(19) United States
(12) Patent Application Publication
(10) Pub. No.: US 2025/0180046 A1
(43) Pub. Date: Jun. 5, 2025

(54) Gripper with shear-induced clamping

(71) Applicant: Georgia Tech Research Corporation, Atlanta, GA (US)

(72) Inventors: Michael Varenberg, Atlanta, GA (US); Jae-Kang Kim, Atlanta, GA (US)

(21) Appl. No.: 19/038,121

(22) Filed: Jan. 27, 2025

Related U.S. Application Data
(63) Continuation-in-part of application No. 18/436,923, filed on Feb. 8, 2024.
Application No. 18/436,923 is a division of application No. 17/798,844, filed on Aug. 10, 2022, now abandoned.
(60) Provisional application No. 62/976,190, filed on Feb. 13, 2020.

(51) Int. Cl. F16B 2/12; B25J 15/00; C09J 7/00

(52) U.S. Cl. CPC F16B 2/12; B25J 15/0033; B25J 15/008; C09J 7/00; C09J 2301/31

(57) ABSTRACT

A structure for adhering to a surface so as to support a desired weight includes a substrate and a polymer layer. The polymer layer is mounted on the substrate. A plurality of flaps are drawn from the polymer layer. Each of the plurality of flaps have dimensions and a density so that when the plurality of flaps are placed against the surface and when a coherent shear force is applied thereto, the plurality of flaps will adhere to the surface with a strength sufficient to support the desired weight.

### CROSS-REFERENCE TO RELATED APPLICATION(S)

This application is a continuation-in-part of U.S. patent application Ser. No. 18/436,923, filed on Feb. 8, 2024, which is a divisional of U.S. patent application Ser. No. 17/798,844, filed on Aug. 10, 2022, which is a US National Phase entry of PCT/US21/17660, filed on Feb. 11, 2021, which claims the benefit of U.S. Provisional Patent Application Ser. No. 62/976,190, filed Feb. 13, 2020, the entirety of each of which is hereby incorporated herein by reference.

### BACKGROUND OF THE INVENTION

1. Field of the Invention

The present invention relates to adhesive structures and, more specifically, to a dry adhesive structure that is inspired by dry biological adhesive structures.

2. Description of the Related Art

Gripping devices are used to grip objects. Conventional gripping devices, such as clamps, magnets, and suction cups, can lift limited ranges of objects.

Shear-activated dry adhesives mimic biological gripping surfaces and are applied to an object by placing the gripping surface against the object. If the gripping surface has sufficient surface contact area with the object, van der Waals forces will hold the gripping surface to the object with sufficient adhesion to support a weight. For example, experimental gripping surfaces applied to a person's hands and feet can be used to support the person on the side of a wall.

Microscale and nanoscale spatulate surface structures enable certain animals to control attachment to many surfaces. For example, a gecko's toes stick to most surfaces, which allow it to climb up the sides of walls and even walk across ceilings. A gecko's foot has ridges on its toes with spatula-shaped bristly fibrils protruding a few dozen microns off the ridges. The fibrils make such thorough contact with surfaces at the nanoscale that weak attractions between atoms on both sides add up enormously to create overall strong adhesion.

Attempts have been made to develop rows of shapes covering materials that produce similar adhesion. One existing shape makes a material's surface look like a field of mushrooms that are a few hundred microns in size. When such mushroom patterns touch a surface, the attractive forces between the patterns and the surface result in the patterns being attached to the surface. However, detaching the patterns requires applying forces in directions that make disengagement difficult.

Many efforts have been made to make reversible shear-activated dry adhesives. A few types of engineered surfaces utilizing the wedge and flap geometry of contact elements have succeeded in mimicking key functions of the biological shear-activated adhesive pads, such as directional adhesion and high friction. Currently, these adhesives are manufactured using template-based molding, with the templates being fabricated by such techniques as photolithography, laser micromachining, and ultraprecision cutting. However, such template-based manufacturing tends to be complex and expensive.

Therefore, there is a need for a shear-activated dry adhesive that is inexpensive and easy to make.

### SUMMARY OF THE INVENTION

The disadvantages of the prior art are overcome by the present invention which, in one aspect, is a structure for adhering to a surface so as to support a desired weight that includes a substrate and a polymer layer. The polymer layer is mounted on the substrate. A plurality of flaps have been drawn from the polymer layer. Each of the plurality of flaps have dimensions and a density so that when the plurality of flaps are placed against the surface and when a coherent shear force is applied thereto, the plurality of flaps will adhere to the surface with a strength sufficient to support the desired weight. Each of the plurality of flaps includes a first side and an opposite second side. At least one of the first side or the second side is meniscus shaped.

In another aspect, the invention is a method of making a gripping surface on a substrate for gripping an object, in which an uncured polymer layer is applied to the substrate. A plurality of spaced-apart drawing elements is dipped into the polymer layer. The drawing elements are drawn away from the substrate so that uncured polymer from the polymer layer adheres to sides of the drawing elements. The polymer is cured. The drawing elements are removed so as to leave cured polymer flaps extending from the polymer layer, the flaps having end areas that adhere to the object when placed against the object and when a shear force is applied to the gripping surface.

In another aspect, the invention is a method of making a gripping surface on a substrate for gripping an object, in which at least one substrate spacer is applied to the substrate. An uncured polymer layer is applied to the substrate so that the uncured polymer layer is substantially as thick as the substrate spacer. The uncured polymer layer is partially cured to a point at which the polymer layer has a predetermined viscosity. A plurality of spaced-apart drawing elements is dipped into the polymer layer. The drawing elements are drawn away from the substrate so that uncured polymer from the polymer layer adheres to sides of the drawing elements so that uncured polymer adhering to the sides of the drawing elements has meniscus shape. The polymer is cured. The drawing elements are removed so as to leave cured polymer flaps extending from the polymer layer. Each of the cured polymer flaps has at least one meniscus shaped vertical side. The cured polymer flaps have end areas that adhere to the object when placed against the object when a lateral shear force is applied to the gripping surface.

In another aspect, the invention is a method of making a gripping membrane, in which a plurality of sheets, each having a pointed edge, is placed against each other with the pointed edge of each sheet directed to a first direction so as to form a mold with a plurality of rows of V-shaped valleys. A polymer is applied to the mold and the polymer is pressed into substantially every space between the razor blades so as to fill the V-shaped valleys with the polymer. The polymer is cured so as to form a gripping membrane. The gripping membrane is removed from the plurality of razor blades.

In another aspect, the invention is a gripping device for securing to an object with an outer surface that includes two flexible shear-activated gripping surface membranes. Each shear-activated gripping surface membrane has a contact surface from which a plurality of elongated flaps extends. A mechanism presses the membranes against the outer surface so that each outer surface applies a tangential force to the elongated flaps on the contact surface of the membranes, thereby causing the elongated flaps to bend in alignment while making contact with the outer surface.

In yet another aspect, the invention is a gripper for securing to an object with an outer surface. Two flexible shear-activated gripping surface membranes each have a contact surface from which a plurality of elongated V-shaped flaps extends, each along a different row. A mechanism presses the membranes against the outer surface so that each outer surface applies a tangential force to the elongated flaps on the contact surface of the membranes. This causes the elongated flaps to bend in alignment while making contact with the outer surface. The mechanism includes a frame, two oppositely disposed membrane supports and a movement device. The two oppositely disposed membrane supports are coupled to the frame. Each of the membrane supports includes two spaced apart arms to which the membrane is attached so that the contact surfaces of the membranes face each other. The two oppositely disposed membrane supports are disposed at an angle relative to the frame so that the outer surface of the object applies the tangential force when the membranes contact the outer surface of the object. The movement device moves the membrane supports.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIGS. 1A-1D are schematic diagrams demonstrating one embodiment of a method of making a gripping surface.

FIG. 2 is an elevational view of two flaps.

FIGS. 3A-3D are a schematic diagrams demonstrating a second embodiment of a method of making a gripping surface.

FIGS. 4A-4C are schematic diagrams of gripping devices.

FIG. 5A-5D are micrographs of flaps generated according to the invention.

FIGS. 6A-6C are photographs of one embodiment of a gripper attaching to an object, lifting the object and then releasing the object.

FIGS. 7A-7E are a series of schematic diagrams showing one method of making a gripping surface.

FIG. 7F is a schematic diagram showing a gripping surface.

FIGS. 8A-8B are schematic diagrams showing one embodiment of a gripping device.

FIGS. 9A-9B are schematic diagrams showing a gripping device picking up an object.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

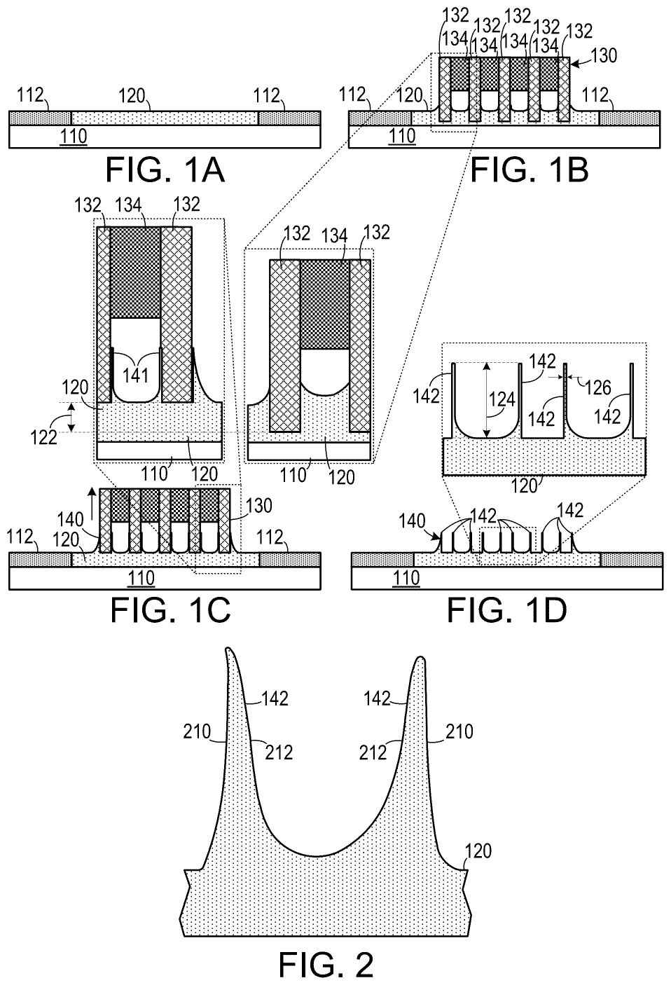

As shown in FIG. 1A, in one embodiment of a method of making a gripping surface 140, a uniform uncured polymer layer 120 is smeared onto a substrate 110. Substrate spacers 112 can be applied to the substrate 110 to limit the thickness of the uncured polymer layer 120 to the thickness of the substrate spacers 112. In one embodiment, the polymer layer 120 includes a two-component polymer (such as, for example, polyvinylsiloxane, PVS, or polyurethane, PU) that is mixed and left to cure partially before being smeared to increase polymer viscosity, which allows the polymer layer 120 to stay on the substrate 110 without flowing out. While polyvinylsiloxane and polyurethane can be used in certain embodiments, the polymer can be one of the many known soft elastomeric curable polymers, selected based on the specific application.

As shown in FIG. 1B, a drawing array 130 is assembled from uniformly spaced and aligned planar elements 132. One experimental embodiment used laboratory razor blades as the aligned drawing elements 132. In one embodiment, the drawing elements 132 are separated with spacers 134 (such as layers of adhesive tape). The spacers 134 are used to accommodate for the polymer layer thickness (which in certain embodiments should not be much larger than the gap between drawing elements 132 to prevent capillary rise).

The drawing array 130 is dipped into the polymer layer 120 to a predetermined distance 122. Then, as shown in FIG. 1C, the drawing layer 130 is drawn away from the substrate 110. As the drawing array 130 is drawn away, the polymer adheres to the drawing elements 132 and one side of the adhering polymer layers 141 naturally develops a meniscus shape. Once the drawing array 130 is drawn away to a desired distance, the polymer layer 120 (and the adhering polymer layers 141) is cured. In one curing method, the polymer 120 is cured with ultra-violet light. In other embodiments, the polymer 120 can heat cured or cured over time with a catalyst that was previously mixed therewith.

As shown in FIG. 1D, once the polymer layer 120 and the adhering polymer layers 141 are cured, the drawing array 130 is removed, leaving a plurality of elongated flaps 142 extending from the polymer layer 120. The flaps 142 act as a gripping surface 140. The flaps 142 have dimensions and a density so that when they are placed against the surface and when a coherent shear force is applied thereto, the flaps will adhere to the surface with a strength sufficient to support the desired weight.

Generally, the dipping distance 122 should be much shorter than the drawing distance due to a possible necking and subsequent disconnection between the drawn flaps and the backing polymer layer. The dipping speed should be as slow as practical to minimize the formation of wrinkles on the polymer surface. The dipping time is also close to the drawing time, which is also measured from the instant of mixing, in order to minimize capillary rise of the polymer through the gap between drawing elements. Such capillary rise can disrupt the fabrication of high-aspect ratio microstructures. Once drawn, the drawing array 130 should be held substantially motionless with respect to the substrate 110 until the polymer layer 120 and flaps 142 are completely cured.

To draw high-aspect ratio flaps 142 upwards and have them fully cured before the polymer can sink back down, the polymer 120 should have a certain viscosity. On the other hand, if the polymer is too viscous, the drawn flaps 142 are excessively stressed, which leads to wrinkles or pores on the cured surface that affect detrimentally its adhesive performance.

In one experimental embodiment, the viscosities of curing PVS and PU mixtures were evaluated by studying their capillary rise in glass tubes as a function of time. In this embodiment, the viscosities of PVS and PU are shown within the time ranges of 30-80 seconds and 50-1320 seconds, respectively. These limits were set by the mixing time on one hand and by the end of the working time on the other hand, while the working time was defined as the time, beyond which no capillary rise is observed. In this experiment, it was found that the best flaps were obtained when the polymer viscosity was about 0.2 of the viscosity at the end of the working time. Drawing at larger viscosities leads to compromised surface quality due to unrelaxed surface stresses and to a more pronounced limitation in the achievable flap height 124 due to flap tearing from the backing layer.

Drawing at smaller viscosities can result in a lower flap height 124 and thickness 126 due to a gravity-driven sinking of the curing polymer and a higher capillary rise between drawing elements. Further, to provide the polymer with the time needed to adjust for the penetration of drawing elements, the polymer viscosity at the time of dipping can be a little lower than 0.1 of the viscosity at the end of the working time. Having these two viscosity limits can result in dipping/drawing times for both PVS and PU that are around 50/70 seconds and 1080/1200 seconds, respectively. The same approach may be used for finding operational regimes for other curing polymers once their time-dependent viscosity and working time are known.

As shown in FIG. 2, each flap 142 has a first side 210 and an opposite second side 212. At least one of the first side 210 or the second side 212 has a meniscus shape. For example, as shown in FIG. 2, the second sides 212 of the flaps 142 are meniscus shaped, whereas the first sides 210 have shapes generally complimentary to the drawing elements 132. In certain embodiments, both sides can be meniscus shaped.

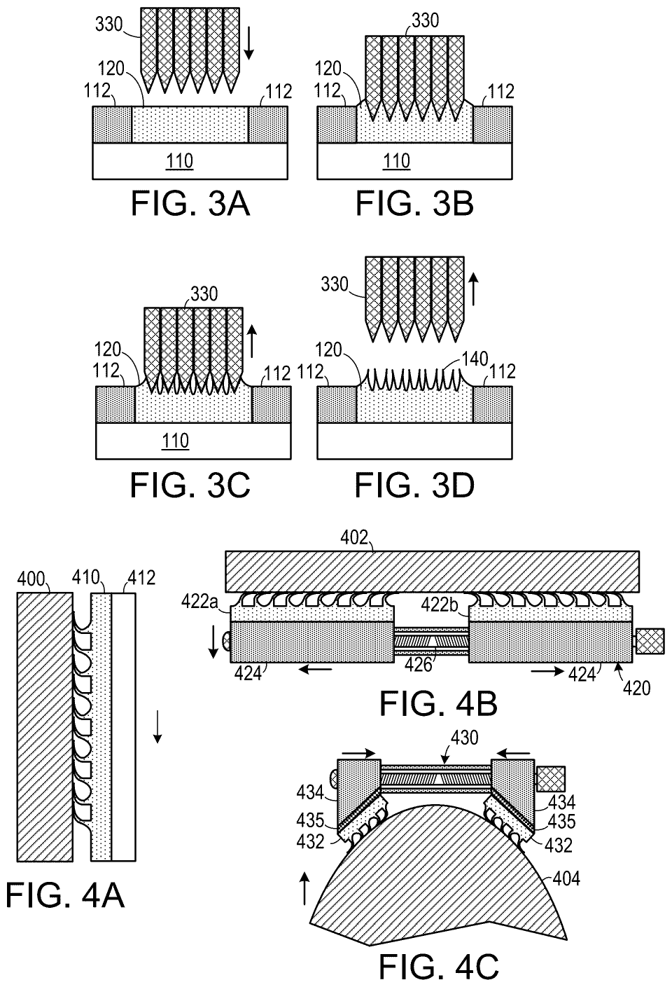

As shown in FIGS. 3A-3D, the drawings elements 330 can have pointed ends, which is the case when the sharp ends of razor blades are used. In such embodiments, spacers (such as items 134 shown in FIGS. 1B-1C) may not be necessary.

The drawing distance defines the microstructure height parameters, of which the flap height is important. With the assumptions that (1) the capillary rise between drawing elements is negligible, (2) the flap thickness is negligible, and (3) the drawing array is large enough for the edge effects to be neglected as well, the ratio of the flap height to the drawing distance should be equal to about 2 if the gap between the U-shaped drawing elements (shown in FIG. 1B) is equal to the drawing element width. This follows from the principle of volume conservation, while it is clear that working with V-shaped drawing elements (shown in FIG. 3B) leads to a different slope. However, the flaps have certain small height due to wetting of the drawing element walls by the curing polymer even before drawing is initiated, and the flap thickness is obviously larger than zero, which makes the flaps a little higher than expected due to a volume conservation-driven adjustment. Drawing the flaps using, for example, wires instead of plates, can result in both flap faces having a meniscus shape.

To adhere a gripping surface of the type disclosed herein, a coherent shear force needs to be applied to the gripping surface so that the flaps all bend in the same direction. This maximizes the contact area between the flaps and the object. One embodiment of a device for adhesion to a vertical surface 400, as shown in FIG. 4A, includes a gripping surface 410 supported by a substrate 412. This embodiment could be used, for example, to hang objects such a paintings, etc. on a wall. Since gravity pulls the object being hung in a downwardly direction, the shear force is automatically applied to the gripping surface 410. In an embodiment of a gripping device 420, as shown in FIG. 4B, the gripping surface has at least two separate parts 422a and 422b. Two substrate parts 424 are laterally separable with a separating structure that applies opposing shear forces. In the embodiment shown in FIG. 4B, the substrate parts 424 include threaded bores and are guided by a rail. A dual threaded screw 426 causes the substrate parts 424 to separate when the screw 426 is turned in one direction and to converge when turned in the opposite direction. This embodiment can be useful, for example, in gripping a flat surface 402, such as a ceiling. An embodiment of a gripping structure 430 that can be used for picking up non-planar objects 404 is shown in FIG. 4C. This embodiment employs substrate blocks 434 that hold the gripping surfaces 432 at a diagonal angle relative to the gripping structure 430. To allow the adhesive microstructures to grip non-planar (differently curved) objects, the gripping surfaces 432 should be supported from behind by a soft backing pad 435 (e.g., a foam). This pad 435 generates light normal load needed to initiate shear-induced attachment along curved surface of a body 404 that has a non-predefined geometry and orientation. Similar backing pads should be use with the structures shown in FIGS. 4A and 4B if the surfaces to which they are attached are not completely flat.

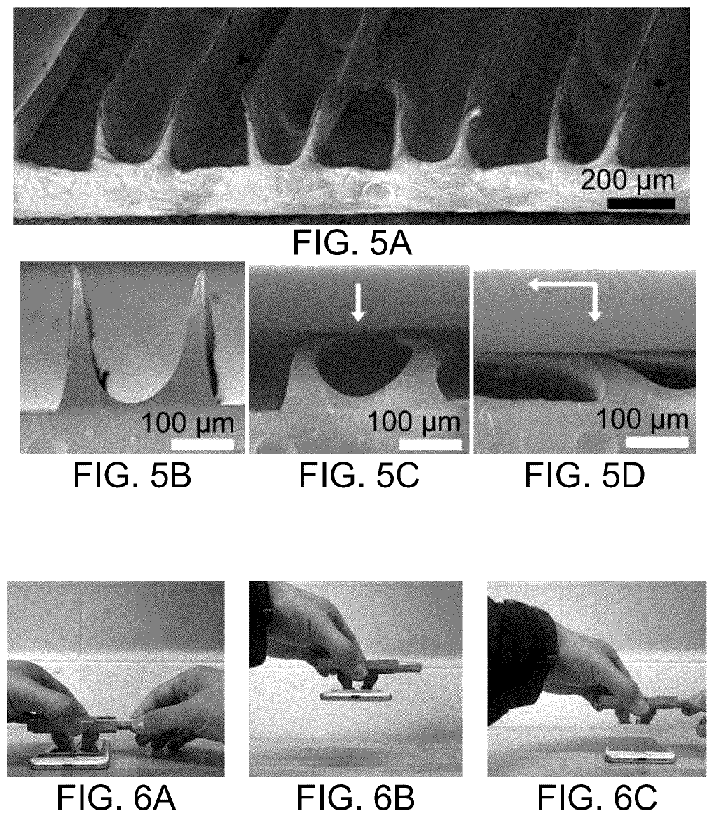

Scanning electron microscopy images of wall-shaped adhesive microstructures are shown in FIGS. 5A and 5B. A scanning electron microscopy image of a gripping structure applied to a surface, in which force is applied in a normal direction, is shown in FIG. 5C and a scanning electron microscopy image of the gripping structure once a coherent shear (i.e., tangential) force has been applied thereto is shown in FIG. 5D.

Photographs demonstrating affixation, lifting and releasing of an object are shown in FIGS. 6A-6C. A gripping structure is adhered to an object by applying opposing shear forces to the gripping surfaces, as shown in FIG. 6A. The object can then be lifted, as shown in FIG. 6B, and the object can be released by removing the opposing shear forces, as shown in FIG. 6C.

In one experimental embodiment, two types of laboratory razor blades were used as drawing elements—thick blades (Pacific Handy Cutter, Costa Mesa, CA) with thickness of 229 μm and the tip angle of 18°, and thin blades (Ted Pella Inc., Redding, CA) with thickness of 76 μm and the tip angle of 22°. Both the sharp (V-shaped) and the blunt (U-shaped) edges of the blades were used for drawing. 3M Scotch Magic 810 (3M, Maplewood, MN) tape was used as a spacer for even separation of adjacent U-shaped drawing elements, whereas the V-shaped drawing elements were assembled without spacers. The blades were aligned and assembled to make microstructures on an area of at least 2.5 mm in width, while the gaps between thick and thin U-shaped drawing elements were about 240 μm and 60 μm (4 and 1 sheet of the spacer tape), respectively, and the gaps between the tips of thick and thin V-shaped drawing elements were 229 μm and 76 μm (blade thicknesses), respectively.

Also, two types of soft polymer composed of base material and curing agent were used to prepare the microstructured surfaces: PolyVinylSiloxane (PVS; Coltène Whaledent, Altstätten, Switzerland) and PolyUrethane (PU; BJB Enterprises, Tustin, CA), with Young's moduli of 3 and 2 MPa, respectively. To fabricate the microstructures, the curing polymer mixture was first smeared onto the glass slide (after dwell times of 30 seconds for PVS and 720 seconds for PU) using a razor blade and spacers to have a uniform thickness of about 300 μm and 180 μm for thick U-shaped and V-shaped drawing elements, respectively, and of about 120 μm for thin drawing elements of both types.

The fabrication was performed using an automatic stepper motor to move the drawing array, a manual stage to adjust the position of the polymer sample, and a camera to observe the process, in a contact angle measurement system OCA 25 (DataPhysics Instruments, Filderstadt, Germany). First, the curing polymer sample was manually brought in contact with the drawing array, and then the motor was used to control the rest of the process. After complete curing of the drawn microstructures, the drawn array was simply detached from the polymer sample in the case of PVS. When working with a much tackier PU, the drawing array and PU sample were disassembled together from the drawing setup, and then they were held in a water-filled M1800H ultrasonic bath (Branson Ultrasonics, Danbury, CT, USA) for an hour before the sample was detached.

The gripper will adhere to almost any surface. This is a clear advantage in manufacturing because one does not have to prepare the gripper for specific surfaces. Such dry adhesives can lift flat objects like boxes and lift curved objects like eggs and vegetables.

In the experimental embodiments, drawing-based manufacturing has been successfully implemented to fabricate dry shear-activated adhesives that demonstrate high flexibility, cost-efficiency, simplicity and scalability of the method. The environmentally-friendly fabrication process can be robustly controlled by such processing parameters as the tool speed, time and displacement during the dipping and drawing stages, making it suitable for mass production.

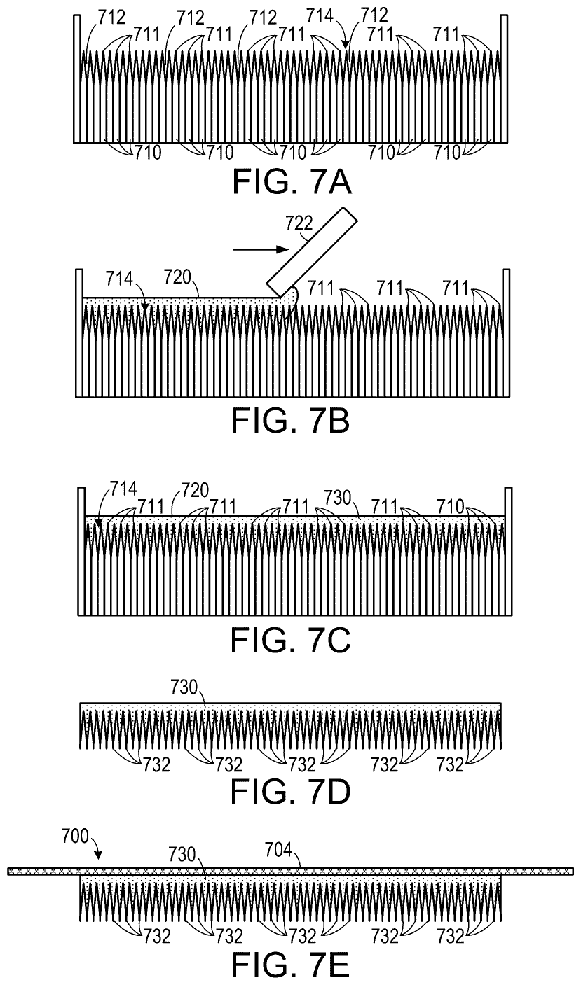

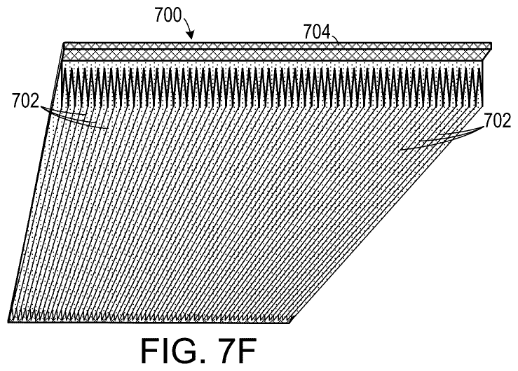

In one embodiment of a method of making a gripping membrane, as shown in FIGS. 7A-7E, a plurality of V-shaped sheets 710 each having a pointed edge 711 (such as razor blades) are placed against each other with the pointed edges 711 all facing the same direction. This forms a mold 714 that defines a plurality of rows of V-shaped valleys 712. A polymer 720 (e.g., polyvinylsiloxane, polyurethane, and combinations thereof) is applied onto the mold 714 and is pressed into substantially every space between the razor blades thereby filling the V-shaped valleys 711. This can be done, for example, by drawing a card 722 with the polymer 720 against the pointed edges 711. The polymer 720 is then cured (e.g., by heating it or through chemical curing with a catalyst mixed in with the polymer 720) so as to form the gripping membrane 730, which is then removed from the mold 714. As shown in FIG. 7F, a flexible back substrate layer 704 (e.g. a woven fabric) can be applied to the polymer prior to curing the polymer, so as to form a shear-activated gripping surface membrane 700 with a plurality of rows of flaps 702.

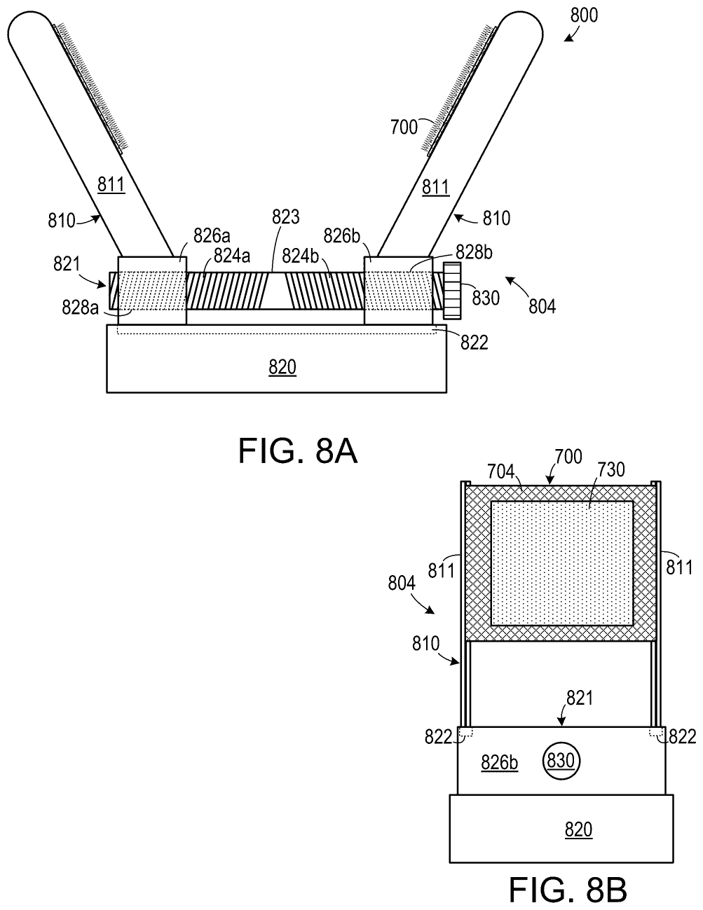

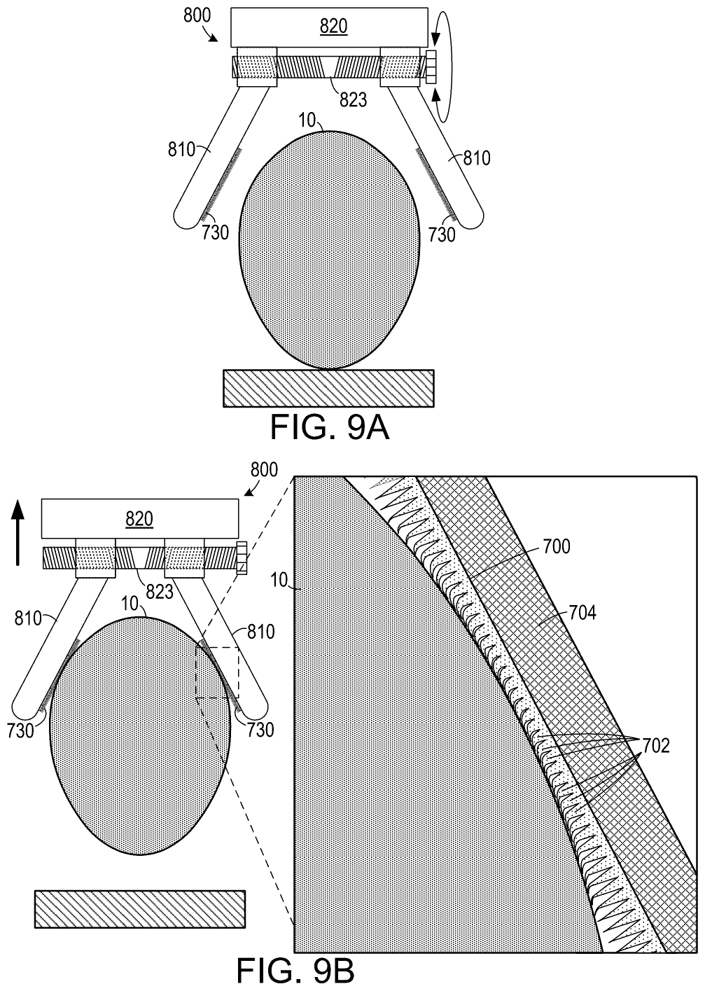

As shown in FIGS. 8A-8B, one embodiment of a gripping device 800 includes a mechanism 804 that is configured to move two flexible shear-activated gripping surface membranes 700 inwardly and outwardly. The mechanism 804 includes a frame 820 and two oppositely disposed membrane supports 810 that are coupled to the frame 820. Each of the membrane supports 810 includes two spaced apart arms 811 to which the membrane 700 is attached so that the contact surfaces 730 of the membranes 700 face each other, the two oppositely disposed membrane supports 810 are disposed at an angle relative to the frame 820. The frame 820 defines a rail 822 into which the membrane supports 810 are engaged. A movement device 821 selectively draws the membrane supports 810 either towards each other or away from each other along the rail 822.

The movement device includes two spaced apart blocks 826a and 826b that are engaged in the rail 822. The first block 826a defines a first threaded hole 828a passing therethrough in which the first threaded hole 828a includes a thread turned in a first direction. The second block 826b defines a second threaded hole 828b passing therethrough in which the second threaded hole 828b includes a thread turned in a second direction opposite the first direction. A double-ended threaded rod 823 includes a first thread 824a that is complementary to the first threaded hole 828a and is engaged therein. A second thread 824b is complementary to the second threaded hole 828b and is engaged therein. As the rod 823 rotates the first block 826a and the second block 826b are forced to move in opposite directions. In a manual embodiment, a knob 830 may be provided to facilitate rotation of the rod 823.

Use of the gripping device 800 to grip an object 10 (in this example, an egg) is shown in FIGS. 9A and 9B. As shown in FIG. 9A, the gripping device 800 is place around the object 10 and the rod 823 is rotated in a direction that causes both membrane supports 810 to move inwardly until the membrane contact surfaces 730 engage the outer surface of the object 10. This causes the object 10 to apply a tangential force to the membrane contact surfaces 730 that translates to a shear force to the flaps 702 extending from the membranes 700 so that the flaps 702 bend in alignment unidirectionally against the object 10. This maximizes the surface area of the flaps 702 in contact with the object 10 so as to maximize the electrical forces attracting the object 10 to the membranes 700. At this point, the object 10 is gripped and may be lifted. To release the object 10, the rod is rotated in the opposite direction, thereby moving the membrane supports 810 away from the object 10 so that the flaps 702 disengage from the object 10.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112 (f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A gripping device for securing to an object with an outer surface, comprising:
(a) two flexible shear-activated gripping surface membranes each having a contact surface from which a plurality of elongated flaps extends; and
(b) a mechanism that presses the membranes against the outer surface so that each outer surface applies a tangential force to the elongated flaps on the contact surface of the membranes, thereby causing the elongated flaps to bend in alignment while making contact with the outer surface.

2. The gripping device of claim 1, wherein each of the flaps comprises a V-shaped row.

3. The gripping device of claim 1, wherein each of the membranes comprises a polymer selected from a list consisting of: polyvinylsiloxane, polyurethane, and combinations thereof.

4. The gripping device of claim 1, wherein the mechanism comprises:
(a) a frame;
(b) two oppositely disposed membrane supports coupled to the frame, wherein each of the membrane supports includes two spaced apart arms to which the membrane is attached so that the contact surfaces of the membranes face each other, the two oppositely disposed membrane supports disposed at an angle relative to the frame so that the outer surface of the object applies the tangential force when the membranes contact the outer surface of the object; and
(c) a movement device for moving the membrane supports.

5. The gripping device of claim 4, wherein the mechanism comprises a rail, defined by the frame, into which the membrane supports are engaged wherein the movement device selectively draws the membrane supports either towards each other or away from each other along the rail.

6. The gripping device of claim 4, wherein the movement device comprises:
(a) two spaced apart blocks engaged in the rail, including a first block defining a first threaded hole passing therethrough in which the first threaded hole includes a thread turned in a first direction and a second block defining a second threaded hole passing therethrough in which the second threaded hole includes a thread turned in a second direction opposite the first direction; and
(b) a double-ended threaded rod including a first thread that is complementary to the first threaded hole and engaged therein, and a second thread that is complementary to the second threaded hole and engaged therein, so that as the rod rotates the first block and the second block are forced to move in opposite directions.

7. The gripping device of claim 1, further comprising a flexible substrate back layer affixed to each of the flexible shear-activated gripping surface membranes.

8. The gripping device of claim 7, wherein the flexible substrate back layer comprises a woven fabric.

9. A gripper for securing to an object with an outer surface, comprising:
(a) two flexible shear-activated gripping surface membranes each having a contact surface from which a plurality of elongated V-shaped flaps extend each along a different row; and
(b) a mechanism that presses the membranes against the outer surface so that each outer surface applies a tangential force to the elongated flaps on the contact surface of the membranes, thereby causing the elongated flaps to bend in alignment while making contact with the outer surface, the mechanism including:
(i) a frame;
(ii) two oppositely disposed membrane supports coupled to the frame, wherein each of the membrane supports includes two spaced apart arms to which the membrane is attached so that the contact surfaces of the membranes face each other, the two oppositely disposed membrane supports disposed at an angle relative to the frame so that the outer surface of the object applies the tangential force when the membranes contact the outer surface of the object; and
(iii) a movement device for moving the membrane supports.

10. The gripper of claim 9, wherein each of the membranes comprises a polymer selected from a list consisting of: polyvinylsiloxane, polyurethane, and combinations thereof.

11. The gripper of claim 9, wherein the mechanism comprises a rail, defined by the frame, into which the membrane supports are engaged wherein the movement device selectively draws the membrane supports either towards each other or away from each other along the rail.

12. The gripper of claim 11, wherein the movement device comprises:
(a) two spaced apart blocks engaged in the rail, including a first block defining a first threaded hole passing therethrough in which the first threaded hole includes a thread turned in a first direction and a second block defining a second threaded hole passing therethrough in which the second threaded hole includes a thread turned in a second direction opposite the first direction; and
(b) a double-ended threaded rod including a first thread that is complementary to the first threaded hole and engaged therein, and a second thread that is complementary to the second threaded hole and engaged therein, so that as the rod rotates the first block and the second block are forced to move in opposite directions.

13. The gripper of claim 9, further comprising a flexible substrate back layer affixed to each of the flexible shear-activated gripping surface membranes.

14. The gripper of claim 13, wherein the flexible substrate back layer comprises a woven fabric that is coupled to each of the membrane supports.

15. A method of making a gripping membrane, comprising the steps of:
(a) placing a plurality of sheets, each having a pointed edge, against each other with the pointed edge of each sheet directed to a first direction so as to form a mold defining a plurality of rows of V-shaped valleys; and
(b) applying a polymer into the mold and pressing the polymer into substantially every space between the razor blades thereby filling the V-shaped valleys with the polymer;
(c) curing the polymer so as to form the gripping membrane; and
(d) removing the gripping membrane from the plurality of razor blades.

16. The gripping device of claim 15, further comprising the step of applying a flexible back substrate layer to the polymer prior to curing the polymer.

17. The gripping device of claim 16, wherein the flexible substrate layer comprises a woven fabric.

18. The gripping device of claim 15, wherein each of the plurality of sheets comprises a razor blade.

19. The method of claim 15, wherein the polymer layer comprises a polymer selected from a list consisting of: polyvinylsiloxane, polyurethane, and combinations thereof.
